(19) United States
(12) Patent Application Publication
(10) Pub. No.: US 2022/0288677 A1
(43) Pub. Date: Sep. 15, 2022

(54) POWDER MATERIAL AND PRODUCING METHOD FOR THE SAME

(71) Applicant: DAIDO STEEL CO, LTD., Nagoya-shi (JP)

(72) Inventors: Koichiro SEKIMOTO, Nagoya-shi (JP); Daisuke KANAI, Nagoya-shi (JP); Teruki USUDA, Nagoya-shi (JP); Toshiyuki YAMANAKA, Nagoya-shi (JP); Takuya SAKAI, Nagoya-shi (JP); Shinnosuke YAMADA, Nagoya-shi (JP)

(21) Appl. No.: 17/689,722

(22) Filed: Mar. 8, 2022

(30) Foreign Application Priority Data
Mar. 11, 2021 (JP) 2021-039104
Jan. 27, 2022 (JP) 2022-011117

(51) Int. Cl. B22F 1/052; B22F 1/054; B22F 9/08

(52) U.S. Cl. CPC B22F 1/052; B22F 1/054; B22F 9/08; B22F 2301/15; B22F 2301/35; B22F 2304/054; B82Y 40/00

(57) ABSTRACT

The present invention relates to a powder material including metal particles, in which in a mass basis cumulative particle size distribution, the metal particles have a 10% particle diameter d₁₀ of less than 16 μm and a 90% particle diameter d₉₀ of more than 35 μm and when a specific energy obtained as a value yielded by dividing a flow energy measured as an energy acting on a blade spiraling upward in the powder material by a mass of the powder material is normalized with a bulk density of the powder material, a resulting value is less than 0.47 mJ·ml/g² and relates to a producing method for the same.

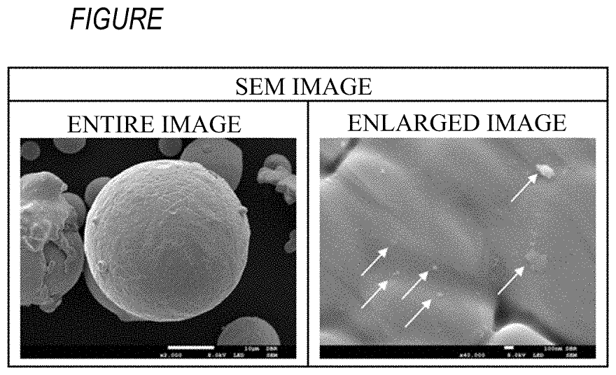

### TECHNICAL FIELD

The present invention relates to a powder material and a producing method for the same. More specifically, the present invention relates to a powder material suitable for use in an additive manufacturing method in which a three-dimensional object is manufactured by forming a powder bed and irradiating it with an energy beam such as laser beam, and method for producing the powder material.

### BACKGROUND ART

In recent years, an additive manufacturing (AM) technique is making a remarkable development as new technology for manufacturing a three-dimensional object. There is, as a kind of additive manufacturing technique, an additive manufacturing method utilizing solidification of a powder material through energy beam irradiation. As an example, a powder bed fusion is representative of the additive manufacturing method using a metal powder material.

Specific examples of the powder bed fusion include a selective laser melting method (SLM), an electron beam melting method (EBM), and other methods. In these methods, a powder material composed of a metal is supplied on a substrate serving as a base to form a powder bed, and a predetermined position of the powder bed is irradiated with an energy beam such as laser beam or electron beam based on three-dimensional design data. As a result, the powder material in the region having received the irradiation solidifies through melting and resolidification, and a shaped body is formed. Supply of the powder material to the powder bed and shaping by energy beam irradiation are repeated, and the shaped body is formed while sequentially building it up in layers, whereby a three-dimensional object is obtained.

In manufacturing a three-dimensional object composed of a metal material by using the above-described additive manufacturing method, a structure having a non-uniform distribution of a constituent material, such as void or defect, is sometimes generated in the obtained three-dimensional object. The generation of such a non-uniform structure is preferably reduced as much as possible. In the additive manufacturing method using a metal material, a plurality of factors can be considered responsible for the generation of the non-uniform distribution of a constituent material in the inside of the manufactured three-dimensional object. As one of the factors, the state of the powder material before energy beam irradiation can greatly affect the state of the obtained three-dimensional object.

For example, in the additive manufacturing method, when the powder material has excellent flowability, the powder material is smoothly supplied and therefore, a powder bed can be stably formed such that the powder material is uniformly spread. Thus, in manufacturing a three-dimensional object by the additive manufacturing method, in the case where the powder material used as a raw material has high flowability, a high-uniformity object is likely to be obtained when a powder bed formed by the powder material is irradiated with an energy beam. For example, in Patent Literature 1, it is intended to improve the flowability of the powder material by limiting the proportion of fine particles with a particle diameter of 20 μm or less based on electron microscope observation to 15% by number or less.

Patent Literature 1: JP-A-2018-172739

### SUMMARY OF INVENTION

In the powder material used as a raw material for additive manufacturing, including the powder material disclosed in Patent Literature 1, fine powders are often conventionally and generally removed as much as possible by performing classification so as to increase the flowability However, in order to obtain a powder bed that a powder material is uniformly spread, which can provide a good-quality three-dimensional object with a suppressed non-uniform distribution of a constituent material in the additive manufacturing method, it is important for the powder material to not only have high flowability but also exhibit high packing density. A powder material in which the flowability is increased by classification does not necessarily exhibit high packing density.

An object that the present invention is intended to attain is to provide a powder material having high flowability and high packing density suitable for the manufacture of a three-dimensional object in the additive manufacturing method, and to provide a producing method for the powder material.

In order to solve the above-mentioned problem, a powder material according to the present invention is a powder material including metal particles,

in which in a mass basis cumulative particle size distribution, the metal particles have a 10% particle diameter d₁₀ of less than 16 μm and a 90% particle diameter d₉₀ of more than 35 μm, and

when a specific energy obtained as a value yielded by dividing a flow energy measured as an energy acting on a blade spiraling upward in the powder material by a mass of the powder material is normalized with a bulk density of the powder material, a resulting value is less than 0.47 mJ·ml/g².

The powder material may have an avalanche angle of less than 40°.

The powder material may have a packing density of 57% or more.

The powder material may further include nanoparticles including a metal or a metal oxide, in addition to the metal particles.

The metal particles may include an iron alloy or a nickel alloy.

The metal particles may have the 10% particle diameter d₁₀ of less than 15 μm and the 90% particle diameter d₉₀ of more than 40 μm.

The metal particles may have the 90% particle diameter d₉₀ of 200 μm or less.

A producing method of the powder material according to the present invention is a producing method for a powder material, including a gas atomization step of producing the metal particles by a gas atomization method.

The producing method for a powder material may include no classification step of removing particles on a small diameter side in a particle size distribution after the gas atomization.

In the powder material according to the present invention, d₁₀ in the particle size distribution is less than 16 μm, i.e., the percentage of particles of less than 16 μm is more than 10%, and the content of fine particles (fine powder) is larger than that in the conventional powder materials, such as the powder material described in Patent Literature 1. On the other hand, d₉₀ is more than 35 μm, and the content of particles having a relatively large particle diameter is also ensured. In this way, both metal particles, i.e., small diameter particles specified by a distribution with d₁₀<16 μm and large diameter particles specified by a distribution with d₉₀>35 μm, are contained, and therefore, a small diameter particle enters a gap between large diameter particles, whereby an effect of increasing the packing density is obtained. More specifically, in the powder material according to the present invention, the particle size distribution range is wide and when the powder material is spread as a powder bed, it is likely that the packing density in the powder bed is enhanced and a high-uniformity powder bed is obtained. Also, in the powder material, when a specific energy obtained as a value yielded by dividing a flow energy measured as an energy acting on a blade spiraling upward in the powder material by the mass of the powder is normalized with the bulk density of the powder material, the resulting value is less than 0.47 mN·ml/g². The specific energy indicates an energy required to disperse metal particle aggregates under an environment where movement of the powder material is not limited, for example, during low-pressure filling. More specifically, the value determined by normalizing the specific energy with the bulk density serves as an index indicating the flowability of the powder material, and as this value is smaller, the powder material has excellent flowability. Hereinafter, the specific energy, the bulk density, and the value obtained by normalizing the specific energy with the bulk density are referred to as SE, ρ_{b}, and SE/ρ_{b} value, respectively.

The powder material according to the present invention contains many metal particles having small diameter as specified by d₁₀<16 μm, and this is effective in increasing the packing density but, on the other hand, may be a factor for decreasing the flowability. However, the SE/ρ_{b} value is kept low, whereby sufficiently high flowability can be ensured. In this way, the powder material according to the present invention satisfies both high flowability and high packing density and allows for smooth formation of a powder bed having a high packing density. As a result, the powder material can be a raw material powder capable of providing a three-dimensional object having a microstructure with high uniformity by additive manufacturing.

Here, in the case where the avalanche angle of the powder material is less than 40°, high flowability can be ensured in the powder material. The avalanche angle is an angle (an angle between the inclined plane of a powder deposition layer and horizontal plane) that causes powder avalanche at the time of introducing a powder into a rotary drum and rotating the drum at a low speed, and as the flowability of the powder is higher, the avalanche angle is smaller.

In the case where the packing density of the powder material is 57% or more, a high-density powder bed can be formed, and a homogeneous additive manufacturing article can be obtained.

In the case where the powder material contains, in addition to metal particles, nanoparticles composed of a metal or a metal oxide, the nanoparticles intervene between adjacent metal particles, and the flowability of the powder material is thereby easily enhanced.

In the case where the metal particle is composed of an iron alloy or a nickel alloy, the powder material can be suitably used as a raw material of a three-dimensional object which is composed of an iron alloy or a nickel alloy and has a large demand for its manufacture utilizing the additive manufacturing method.

In the case where the 10% particle diameter d₁₀ of metal particles is less than 15 μm and the 90% particle diameter d₉₀ is more than 40 μm, the powder material has a still wider particle size distribution, and the effect of enhancing the packing rate further increases.

The method for producing metal particles according to the present invention includes a step of producing metal particles by a gas atomization method. Producing metal particles by a gas atomization method facilitates production of particles having a micron-order particle diameter and high roundness and in turn, exhibiting high flowability, for various alloy compositions. In addition, when a gas atomization method is used, at the time of production of metal particles, nanoparticles are sometimes simultaneously produced on the metal particle surface by using a constituent component of the metal particle as a raw material. This nanoparticle can contribute to enhancing flowability of the powder material. In particular, since nanoparticles are produced in the state of being attached to the metal particle surface, the effect of enhancing the flowability is stably obtained.

Here, in the case of not conducting a classification step of removing particles on the small diameter side in the particle size distribution, metal particles constituting the powder material comes to have a wide particle size distribution, as a result, it is facilitated to increase the packing density of the powder material. Also, adjustment of the particle size by, e.g., external addition of small diameter particles for realizing a particle size distribution satisfying d₁₀<16 μm may possibly be omitted, and the production process of the powder material can be simplified. In cooperation with the effects achieved by producing metal particles by a gas atomization method, that is, the effects that metal particles exhibiting high flowability are easily obtained due to production of metal particles with high roundness or production of nanoparticles, a powder material excellent in both flowability and filling property can be produced at low cost.

### BRIEF DESCRIPTION OF DRAWINGS

The FIGURE is an SEM image (left-side image: the scale bar indicates 10 μm) of metal particles contained in the powder material according to an embodiment of the present invention, and an enlarged image of the metal particle surface (right-side image: the scale bar indicates 100 nm).

### DESCRIPTION OF EMBODIMENTS

The powder material according to an embodiment of the present invention is described in detail below. The powder material according to an embodiment of the present invention can be used as a raw material for, in the additive manufacturing method, constituting a powder bed and manufacturing a three-dimensional object by energy beam irradiation.

The configuration of the powder material according to an embodiment of the present invention, the properties of the powder material, and the production method of the powder material are described.

The powder material according to the present embodiment is a powder material containing metal particles having a particle size distribution in which in a mass basis cumulative particle size distribution the 10% particle diameter d₁₀ is less than 16 μm and the 90% particle diameter d₉₀ is more than 35 μm. In addition to such metal particles, the powder material according to the present invention may contain nanoparticles. As long as the above-described particle size distribution and the predetermined SE/ρ_{b} value described later are satisfied, the powder material according to the present embodiment may contain components other than metal particles and optionally contained nanoparticles. However, components other than metal particles and nanoparticles are preferably not contained except for unavoidable impurities.

### (1) Metal Particles

In the mass basis cumulative particle size distribution of metal particles contained in the powder material according to the present embodiment, d₁₀ is less than 16 μm and d₉₀ is more than 35 μm. Being d₁₀<16 μm means that in the entire particle size distribution, many small diameter particles having a particle diameter of about 10 μm are contained. On the other hand, being d₉₀>35 μm means that in the particle size distribution, inclusion of particles having a relatively large particle diameter is also ensured. In this way, the particle size distribution spreads a wide range of particle diameters, and this allows the powder material to provide a high packing density. If the powder material is composed of only large metal particles, in the step of spreading the powder material, a gap is generated at a portion where metal particles are adjoined with themselves, and the packing density in the powder bed is reduced. However, the metal particles according to the present embodiment has a wide particle size distribution, so that the packing density in the powder bed can be enhanced by filling the gap between large diameter particles with small diameter particles (fine powder).

From the viewpoint of increasing the effect of enhancing the packing density by broadening the range of the particle size distribution that the powder material has, in the particle size distribution of the powder material, it is more preferred that d₁₀ is less than 15 μm and also, it is more preferred that d₉₀ is more than 40 μm.

In view of flowability of the powder material, the lower limit of d₁₀ is not particularly limited, but if the particles are too small, they can hardly contribute to the enhancement of the packing density. Therefore, the lower limit d₁₀ may be 1 μm or more. The upper limit of d₉₀ is not particularly limited as well, but considering the particle diameter of metal particles commonly used as a raw material in additive manufacturing, the upper limit of d₉₀ may be, for example, 200 μm or less. Furthermore, from the same viewpoint, the average particle diameter d₅₀, which is the 50% particle diameter in the mass basis cumulative particle size distribution, is preferably 10 μm or more and 150 μm or less.

As long as the powder material has the above-described particle size distribution and provides the SE/ρ_{b} value described later, the metal constituting the metal particle is not particularly limited, but an iron alloy, a nickel alloy, a cobalt alloy, or a titanium alloy can be suitably used. More preferably, an iron alloy or a nickel alloy is used. The iron alloy and nickel alloy are in high demand in additive manufacturing, and a powder material containing, as a main component, an iron alloy or a nickel alloy can be suitably used as a raw material for additive manufacturing. As the iron alloy, among others, an alloy having a component composition corresponding to various stainless steels or tool steels is particularly suitable for use.

### (2) Nanoparticles

The powder material according to the present embodiment may contain nanoparticles. Nanoparticles contained in the powder material are effective in enhancing flowability of the powder material, and since nanoparticles intervene between metal particles and reduce the attractive interaction acting between metal particles, an effect of decreasing the adhesive force between metal particles is obtained. The nanoparticles contained in the powder material may be one kind or a plurality of kinds.

Nanoparticles may be attached to the metal particle surface or may be independent of metal particles and dispersed in a space between metal particles. Preferably, from the viewpoint of, e.g., stabilizing the distribution of nanoparticles, they are better attached to the metal particle surface. The nanoparticle is preferably composed of a metal or a metal oxide. The nanoparticles may be nanoparticles derived and produced from a constituent component of the above-described metal particles or may be nanoparticles added separately from the metal particles. Examples of the nanoparticles derived and produced from a constituent component of the metal particle include a configuration where, as described later regarding the production method of metal particles, nanoparticles derived from a constituent component of the meal particle are produced in the state of being attached to the metal particle surface at the time of forming metal particles by a gas atomization method. In the case where the nanoparticles are composed of a metal oxide, preferable metal oxides include SiO₂, Al₂O₃, TiO₂, etc. These metal oxides hardly exert a serious effect even when they are contained in a three-dimensional object composed of a metal through an additive manufacturing step. Nanoparticles composed of a metal oxide are better prepared separately from metal particles and added to the metal particles.

The particle diameter of nanoparticles is not particularly limited as long as it is on the nanometer order, but the particle diameter is preferably, for example, 1 nm or more and 100 nm or less. The shape of the nanoparticle is not particularly limited as well, and the nanoparticle may have any particle shape such as substantially spherical shape, polyhedral shape or irregular shape. Among others, in the case of adding nanoparticles separately from metal particles, preferably, from the viewpoint of effectively enhancing the flowability of the powder material, the nanoparticles may be substantially spherical particles. The amount of nanoparticles contained in the powder material is not particularly limited, but, for example, from the viewpoint of obtaining a high effect of enhancing the flowability, the amount of nanoparticles may be 0.001 mass % or more based on the mass of metal particles. On the other hand, from the viewpoint of, e.g., avoiding an effect on the quality of a three-dimensional object due to containing an excessive amount of nanoparticles, the amount of nanoparticles contained in the powder material may be 0.1 mass % or less. Incidentally, nanoparticles have substantially no effect on the mass basis particle size distribution of the powder material because of their small amount.

(3) Properties of Powder Material

In the powder material according to the present embodiment, a value (SE/ρ_{b}: mJ·ml/g²) obtained by dividing a specific energy (SE: mJ/g) indicative of flowability of the powder material by the bulk density (ρ_{b}: g/ml) of the powder material is taken as an index of the flowability of the powder material, and the SE/ρ_{b} value is kept less than 0.47 mJ·ml/g². SE is an energy required to disperse metal particle aggregates in the powder material by shear under a low stress environment. More specifically, under an environment where the powder material is not constrained, for example, during low-pressure filling, when an impeller-shaped blade is caused to spiral upward while rotating in the powder material, the specific energy (SE) is calculated from the shear force applied to the blade. The specific energy (SE) increases when strong aggregation is caused between particles of the powder material and the flowability of the powder material is low.

In the measurement of the SE value of the powder material, a powder flow analyzer can be used. Specific examples of the analyzer include FT4 powder rheometer manufactured by Freeman Technology.

In this way, the SE/ρ_{b} value serves as an index of the flowability of the powder material, and a smaller value indicates that the flowability of the powder material is higher. In the powder material according to the present embodiment, the SE/ρ_{b} value is less than 0.47 mJ·ml/g², and the adhesive force (attractive force) acting between particles is thereby kept low, allowing the powder material to have high flowability. In the case where the SE/ρ_{b} value of the powder material is less than 0.47 mJ·ml/g², the powder material according to the present embodiment comes to have good flowability. Then, in the additive manufacturing step, supply of the powder material to a powder bed and spreading of the powder material in the powder bed are smoothly performed, and a homogeneous and high-density powder bed can be provided. As a result, a good-quality three-dimensional object can be obtained. The means for keeping the SE/ρ_{b} value low is not particularly limited but includes, for example, addition of nanoparticles to metal particles described above, enhancement of the roundness of metal particles, removal of water, and other means. The lower limit of the SE/ρ_{b} value need not be specified but, in the metal powder such as iron alloy, may be about 0.3 m·ml/g² or more.

In the powder material, when the SE/ρ_{b} value is small, the avalanche angle (Φ) tends to decrease. The avalanche angle is a value obtained by observing the flow behavior of a powder lifted upward as the vessel rotates when a cylindrical vessel containing a predetermined amount of powder is slowly rotated, and indicates an angle (an angle between the inclined plane of a powder deposition layer and the horizontal plane) of the powder just before an avalanche occurs as a result of losing the balance between interparticle adhesive force and gravity. In the case where the SE/ρ_{b} value is small and the adhesive force acting between particles is small, the flowability of the powder increases and in turn, the avalanche angle (θ) decreases.

The avalanche angle (Φ) of the powder material according to the present embodiment is preferably less than 40°, more preferably less than 35°. In the case where the avalanche angle (Φ) of the powder material is less than 40°, the powder material has more excellent flowability, as a result, in the additive manufacturing method, a step that the flowability of the powder material affects, such as supply of the powder material, is smoothly performed, and this makes it easy to enhance the spread density in a powder bed and the smoothness of the powder bed surface, so that a good-quality three-dimensional object can be obtained. The lower limit of the avalanche angle of the powder material is not particularly limited but, in this kind of metal powder composed of an iron alloy or a nickel alloy, etc., may be about 15° or more.

In this way, the powder material according to the present embodiment contains many small diameter particles as specified by d₁₀<16 μm and therefore, exhibits a high packing density. The packing density can be quantitatively evaluated as a value (ρ_{b}/ρₜ×100%) obtained by dividing a bulk density (ρ_{b}) by a true density (ρₜ). In the powder material according to the present embodiment, the packing density is preferably 57% or more. This effectively contributes to sufficiently increasing the spread density of a powder material in a powder bed formed by the powder material and increasing the spatial uniformity of the constituent material in a three-dimensional object obtained by the additive manufacturing method. The upper limit of the packing density is not particularly specified but, in this kind of metal powder composed of an iron alloy or a nickel alloy, etc., is about 90% or less.

Possessing a particle size distribution of d₁₀<16 μm and d₉₀>35 μm and an SE/ρ_{b} value of less than 0.47 mJ·ml/g² allows the powder material to have high flowability and high packing density, and the powder material can suitably be used as a raw material in additive manufacturing. For example, in the case of conducting, among additive manufacturing methods, a powder bed fusion such as SLM method or EBM method, the powder material is supplied from a hopper and spread on a substrate to form a powder bed. At this time, in the case where the powder material has an SE/ρ_{b} value of less than 0.47 mJ·ml/g², thereby allowing the powder material to have high flowability, the powder material can stably flow out of the hopper. Also, at the time of spreading the powder material using a recoater, etc. to form a powder bed, since the powder material has high flowability, spreading can be smoothly performed. In addition, the particle size distribution of the powder material covers a wide range of fine powders, and this facilitates performing spreading of the powder material at a high density and homogeneously. Thus, in stably forming a powder bed with uniformity and high density, it is important for the powder material to have high flowability and high filling property. The increase in the flowability and filling property of the powder material makes it possible to spread the powder material densely and smoothly, and at the time of forming a powder bed, high spreadability is obtained. The powder bed having high uniformity and high density is then irradiated with an energy beam to perform additive manufacturing, and formation of a homogeneous three-dimensional object with little defects is thereby facilitated.

### (4) Production Method of Powder Material

The production method of the above-described powder material according to the present embodiment is not particularly limited, but the powder material can be suitably produced by using the below-described production method for a powder material according to the present embodiment.

First, metal particles serving as a raw material of the powder material need to be prepared. The method for producing metal particles is not particularly limited, but it is preferable to use a gas atomization method. In the gas atomization method, an alloy melt is sprayed in vacuum, and an inert gas such as nitrogen gas or argon gas is blown against the sprayed alloy melt to thereby obtain metal fine particles. In the gas atomization method, the shape of metal particles is easily caused to approximate a spherical shape and furthermore, the particle diameter and particle surface state can be controlled by the conditions such as dimension of a nozzle (aperture angle, etc.) for spraying the alloy melt or gas pressure. For example, in the case where a metal element that is more sublimable than other component metal elements (Fe, etc.), such as Al, Mg, Cu or Sn, is contained in the component composition of the alloy melt, it is also possible in the gas atomization method to let such a metal element sublimate and solidify on the metal particle surface and thereby produce, together with metal particles having a desired micron-order particle diameter, metal particle component-derived nanoparticles in the state of being attached to the metal particle surface. As for the conditions capable of promoting sublimation of constituent components of metal particles, this can be achieved, for example, by selecting the type (aperture angle, etc.) of a gas nozzle used or, in an apparatus, lowering the pressure in an area where pulverization of molten metal is performed. In this way, preparing metal particles by gas atomization method enables formation of metal particles having high sphericity and moreover, by appropriately promoting formation of nanoparticles, the powder material can be simply and easily produced with high flowability.

Furthermore, in the powder material of the present embodiment, metal particles obtained by the above-described gas atomization method are preferably not subjected to classification on the small diameter side that is performed in the conventional production process. In the conventional production process, the flowability of the powder material is enhanced by removing fine powder through classification. However, as described above, the powder material according to the present embodiment contains many fine powders as represented by the particle size distribution with d₁₀<16 μm, and high filling property is thereby realized. Omitting removal of fine powders by classification in the production process makes it easy to obtain a particle size distribution containing many fine powders. In the case where the fine powder removal step is not performed, reduction in cost and enhancement of yield can be achieved. In addition, a step of adding separately prepared fine powder to a powder material containing many large diameter particles is unnecessary as well.

Incidentally, from the viewpoint of adjusting the particle size distribution and promoting production of nanoparticles, heating such as thermal plasma treatment may be appropriately performed after the production of metal particles by a gas atomization method. Although metal particles obtained by a gas atomization method may have undergone secondary aggregation, the aggregation is eliminated by performing heating. When metal particles are further heated, the microstructure in the vicinity of the metal particle surface melts or sublimates and at the time of rapid solidification on the metal particle surface, nanoparticles are produced on the metal particle surface through resolidification by using the melted or sublimated material as a raw material.

In addition, after the production of metal particles by a gas atomization method and/or after the heating treatment, nanoparticles composed of a metal oxide, etc. may be separately added. The flowability of the powder material can further be enhanced by the production of metal particle-derived nanoparticles and/or the external addition of metal oxide nanoparticles.

### EXAMPLES

The present invention is described more specifically below by referring to Examples. Here, the relationships of the particle size distribution and SE/ρ_{b} value of the particle material with flowability and filling property and furthermore, with spreadability were examined Each evaluation was performed at room temperature in the atmosphere. The present invention is not limited by the following Examples.

### [1] Relationship Between Condition and Properties of Powder Material

### (Preparation of Sample)

Metal Particles were produced by a gas atomization method using an iron alloy or a nickel alloy as a raw material. At the time of production of metal particles by a gas atomization method, the pressure of a recirculation zone formed by atomization gas was adjusted to less than −55 kPaG by adjusting the nozzle aperture angle and the gas pressure so as to not only adjust the particle diameter but also produce nanoparticles by letting them to attach to the surface. The thus-obtained metal particles had a diameter in the range of 20 μm or more and 50 μm or less in terms of the average particle diameter. The obtained metal particles were not subjected to classification. In this way, a plurality of powder material samples was prepared (Samples 1 to 8). With respect to these produced samples, the following examinations were performed.

### (Evaluation of Particle Size Distribution)

The particle size distribution of each powder material was measured using a laser diffraction/scattering analyzer in conformity with JIS Z 8825:2013.

### (Evaluation of Morphology of Powder Material)

The produced metal particles were observed using a scanning electron microscope (SEM). With respect to a representative sample, the FIGURE illustrates an observation image. The sample used for the observation of the FIGURE is the sample of Sample 3 in Table 1 and is a sample in which the d₁₀ value is 13.8 μm and the SE/ρ_{b} value is 0.45 mJ·ml/g². The raw material is a tool steel of JIS SKD-61 (JIS G 4404:2015).

### (Evaluation of SE/ρ_{b} Value)

The SE/ρ_{b} value is evaluated by dividing the specific energy (SE) value by the bulk density (ρ_{b}). SE and ρ_{b} were measured using “FT4 Powder Rheometer” manufactured by Freeman Technology. In the measurement, a 23.5 mm-diameter blade and a 25-mm cylindrical split vessel were used. The cylindrical split vessel was filled with each sample of the metal powder material, and by rotating the blade upward, the shear force applied to the powder material from the blade was measure and used as SE. The measurement environment was at room temperature of 15° C. or more and 30° C. or less and a humidity of less than 20%. The thus-measured SE was divided by ρ_{b} to afford the SE/ρ_{b} value.

### (Evaluation of Avalanche Value)

The avalanche angle (Φ) was evaluated using “Revolution Powder Analyzer” manufactured by Mercury Scientific Inc. The analyzer is an apparatus including a cylindrical rotary drum for housing the powder material and a CCD camera for taking a picture of the interior of the drum and continuously recording the behavior of the powder material. When a predetermined amount of the powder material is put in the rotary drum and the drum is rotated at a low speed (0.6 rpm), the powder deposit layer lifts upward as the drum rotates, and an avalanche occurs when the balance between interparticle adhesive force and gravity is lost. The state when an avalanche occurred was recorded by the CCD camera, and the flowability of the powder material was evaluated by taking, as the avalanche angle (Φ), an angle of the powder material (an angle between the inclined plane of a powder deposition layer and horizontal plane) when an avalanche occurred.

### (Evaluation of Packing Density)

The packing density (hereinafter, the packing density is denoted by ρ_{f}) is calculated as bulk density (ρ_{b})/true density (ρₜ). As for the true density (ρₜ), a calculated value obtained using a material physical value calculation software (JMatPro) produced by Sente Software Ltd. was employed. The bulk density (ρ_{b}) was the same as the value used for the calculation of the SE/ρ_{b} value.

### (Evaluation Results) <State of Metal Particles>

An SEM image of a representative produced sample is shown in the FIGURE. It is seen from the image that the shape of metal particles contained in the powder material is almost spherical and moreover, as illustrated in the enlarged diagram, many nanoparticles are attached to the metal particle surface. In response to employing a gas atomization method for the preparation of metal particles, the shape of metal particles is substantially spherical. Furthermore, it is considered that out of metals contained in the raw material of metal particles, a sublimable metal is sublimated in the gas atomization step and solidified on the metal particle surface and, as a result, nanoparticles are attached to the metal particle surface. Incidentally, the sample used for acquiring the SEM image of the FIGURE is the sample of Sample 3.

### <Properties of Powder Material>

Out of all samples, with respect to the samples where d₉₀>35 μm, the d₁₀ and SE/ρ_{b} values, avalanche angle (Φ) and packing density (ρ_{f}) were measured and summarized in Table 1 for each of Samples 1 to 8.

TABLE 1

| | d₁₀ | SE/ρ_{b} | Avalanche | Packing |
|---|---|---|---|---|
| | [μm] | [mJ · mL/g²] | Angle [°] | Density [%] |
| Sample 1 | 15.2 | 0.44 | 28.8 | 59 |
| Sample 2 | 13.6 | 0.44 | 31.0 | 58 |
| Sample 3 | 13.8 | 0.45 | 32.8 | 58 |
| Sample 4 | 15.6 | 0.40 | 30.2 | 58 |
| Sample 5 | 10.8 | 0.64 | 37.5 | 55 |
| Sample 6 | 10.5 | 0.61 | 38.6 | 56 |
| Sample 7 | 11.1 | 0.61 | 41.0 | 57 |
| Sample 8 | 13.4 | 0.53 | 40.8 | 55 |

As seen from Table 1, in all of Samples 1 to 4 where d₁₀ in the particle size distribution of the powder material is less than 16 μm and the SE/ρ_{b} value is less than 0.47 mJ·ml/g², the avalanche angle (Φ) is less than 40° and the packing density (ρ_{f}) is 57% or more. On the other hand, as revealed by Samples 5 to 8, even when the d₁₀ value of the powder material is less than 16 μm, unless the SE/ρ_{b} value is less than 0.47 mJ·ml/g², a small avalanche angle of less than 40° and a high packing density of 57% or more cannot be obtained. It is understood from this that as long as the particle size distribution of the powder material satisfies the condition of having d₁₀ of less than 16 μm and d₉₀ of more than 35 μm and furthermore, SE/ρ_{b} is less than 0.47 mJ·ml/g², a powder material having high flowability, thereby in turn providing a small avalanche angle and increasing the packing density in a powder bed, which is suitable for additive manufacturing, can be obtained.

### [2] Spreadability of Powder Material

For the purpose of evaluating whether when the powder material is characterized in that d₁₀ in the particle size distribution is less than 16 μm and the SE/ρ_{b} value is 0.47 mJ·ml/g² or less, the powder material can be appropriately spread, evaluation of the spreadability of the powder material was performed in the following manner.

### (Method for Evaluating Spreadability of Powder Material)

Powder beds were actually formed by an additive manufacturing apparatus using Sample 2, Sample 4 and Sample 8 shown in Table 1 and spreadability of each powder bed was evaluated. Sample 2 and Sample 4 are samples where d10 is less than 16 μm and the SE/ρ_{b} value is less than 0.47 mJ·ml/g², and Sample 8 is a sample not satisfying the ranges above. The evaluation results are summarized in Table 2. Incidentally, from the viewpoint of complementing the evaluation of the spreadability, in addition to Samples 2, 4 and 8, commercially available powder materials were separately prepared as reference samples, and these reference samples were also measured for the avalanche angle and packing density in accordance with the same measurement method as in the test [1] above and evaluated for the spreadability.

At the time of evaluating the spreadability of each sample, “Metal 3D Printer M2” manufactured by Concept Laser GmbH was used as the additive manufacturing apparatus, a predetermined amount of the powder material was introduced into the apparatus, and spreading by a recoater was performed at a rate of 100 mm/s to form a spreading area (powder bed) of 245 mm×245 mm The powder deposition layer thickness was set to 50 μm, and spreading was performed by supplying the powder material in an amount corresponding to twice the deposition layer thickness. A picture of the surface of the powder bed was taken by a built-in camera of the apparatus, and the spreadability was evaluated by setting, as the measurement region, a region of 220 mm×220 mm within the captured image. In the captured image obtained, since a region filled with the powder material at a higher density is imaged in higher brightness, provided that a region having gained a brightness above a reference value corresponding to a spreading density enabling additive manufacturing to be performed without problem is a region (region a) where the powder material is sufficiently spread and that a region with the brightness being less than the threshold value above is a region (region b) where spreading of the powder material is insufficient, and the area of each region was estimated through binarization. Furthermore, an effective area ratio (%) was calculated using the following formula. When the effective area ratio is 98% or more, the sample was judged as “spreadability is good” and rated “A”, and when it is less than 98%, the sample was judged as “spreadability is poor” and rated ^{B.} The results are shown in Table 2.

Effective area ratio (%)=area of region a×100/area of measurement region

### (Evaluation Results: Spreadability)

Powder beds were actually formed using powder materials of Sample 2, Sample 4 and Sample 8 of Table 1 and separately prepared Reference Sample 1 and Reference Sample 2, and whether or not the powder bed is uniformly filled with the powder material of each sample was evaluated by the method described above. The results are shown in Table 2. In both of Sample 2 and Sample 4 of Table 2, d₁₀ in the particle size distribution of the powder material is less than 16 μm and the SE/ρ_{b} value is less than 0.47 mJml/g², whereas in all of Sample 8, Reference Sample 1 and Reference Sample 2, the SE/ρ_{b} value is 0.47 mJ·ml/g² or more. With respect to both Samples 2 and 4 where the SE/ρ_{b} value is less than 0.47 mJml/g², the spreadability was “A” and judged as “good”, while on the contrary, with respect to all of Sample 8, Reference Sample 1 and Reference Sample 2 where the SE/ρ_{b} value is 0.47 mJ·ml/g² or more, the spreadability was “B” and judged as “poor”.

The spreadability difference above can be associated with the flowability and packing density of the powder material. As described in the test of [1], since the avalanche angle is less than 40° and small and the packing density is 57% or more and high, both of Sample 2 and Sample 4 have high flowability and provide a high packing density in the powder bed. On the other hand, in Sample 8, Reference Sample 1 and Reference Sample 2, the avalanche angle is more than 40°, or the packing density is less than 57%. Hence, it could be said that when the powder material satisfies the condition that d₁₀ in the particle size distribution is less than 16 μm and the SE/ρ_{b} value is less than 0.47 mJml/g², a small avalanche angle and a high packing density are obtained and, whereby the powder material exhibits high spreadabililty at the time of forming a powder bed and is uniformly packed.

TABLE 2

| Sample | d₁₀ | SE/ρ_{b} | Avalanche | Packing | |
|---|---|---|---|---|---|
| Name | [μm] | [mJ · ml/g²] | Angle [°] | Density [%] | Spreadability |
| Sample 2 | 13.6 | 0.44 | 31.0 | 58 | A |
| Sample 4 | 15.6 | 0.40 | 30.2 | 58 | A |
| Sample 8 | 13.4 | 0.53 | 40.8 | 55 | B |
| Reference | 14.6 | 0.68 | 43.7 | 55 | B |
| Sample 1 | | | | | |
| Reference | 11.7 | 0.61 | 38.9 | 55 | B |
| Sample 2 | | | | | |

In the foregoing pages, embodiments and Examples of the present invention have been described. The present invention is not limited to these embodiments and Examples, and various modifications can be made therein.

The present application is based on Japanese Patent Application No. 2021-039104 filed on Mar. 11, 2021 and Japanese Patent Application No. 2022-011117 filed on Jan. 27, 2022, and the contents thereof are incorporated herein by reference.

What is claimed is:

1. A powder material comprising metal particles,
wherein in a mass basis cumulative particle size distribution, the metal particles have a 10% particle diameter d₁₀ of less than 16 μm and a 90% particle diameter d₉₀ of more than 35 μm, and
when a specific energy obtained as a value yielded by dividing a flow energy measured as an energy acting on a blade spiraling upward in the powder material by a mass of the powder material is normalized with a bulk density of the powder material, a resulting value is less than 0.47 mJ·ml/g².

2. The powder material according to claim 1, wherein the powder material has an avalanche angle of less than 40°.

3. The powder material according to claim 1, wherein the powder material has a packing density of 57% or more.

4. The powder material according to claim 2, wherein the powder material has a packing density of 57% or more.

5. The powder material according to claim 1, wherein the powder material further comprises nanoparticles comprising a metal or a metal oxide.

6. The powder material according to claim 2, wherein the powder material further comprises nanoparticles comprising a metal or a metal oxide.

7. The powder material according to claim 3, wherein the powder material further comprises nanoparticles comprising a metal or a metal oxide.

8. The powder material according to claim 4, wherein the powder material further comprises nanoparticles comprising a metal or a metal oxide.

9. The powder material according to claim 1, wherein the metal particles comprise an iron alloy or a nickel alloy.

10. The powder material according to claim 2, wherein the metal particles comprise an iron alloy or a nickel alloy.

11. The powder material according to claim 3, wherein the metal particles comprise an iron alloy or a nickel alloy.

12. The powder material according to claim 4, wherein the metal particles comprise an iron alloy or a nickel alloy.

13. The powder material according to claim 5, wherein the metal particles comprise an iron alloy or a nickel alloy.

14. The powder material according to claim 6, wherein the metal particles comprise an iron alloy or a nickel alloy.

15. The powder material according to claim 7, wherein the metal particles comprise an iron alloy or a nickel alloy.

16. The powder material according to claim 8, wherein the metal particles comprise an iron alloy or a nickel alloy.

17. The powder material according to claim 1, wherein the metal particles have the 10% particle diameter d₁₀ of less than 15 μm and the 90% particle diameter d₉₀ of more than 40 μm.

18. The powder material according to claim 1, wherein the metal particles have the 90% particle diameter d₉₀ of 200 μm or less.

19. A producing method for a powder material according to claim 1, the method comprising a gas atomization step producing the metal particles by a gas atomization method.

20. The producing method according to claim 19, comprising no classification step of removing particles on a small diameter side in a particle size distribution after the gas atomization step.
